(19) United States
(12) Patent Application Publication
(10) Pub. No.: US 2011/0073645 A1
(43) Pub. Date: Mar. 31, 2011

(54) ARTICLE SALES DATA PROCESSING APPARATUS AND TRANSACTION DISPLAY METHOD

(75) Inventors: Yumiko Okuma, Tokyo (JP); Maki Sato, Kanagawa (JP); Nobuhiro Sugita, Shizuoka (JP); Satoru Ishihara, Tokyo (JP)

(73) Assignee: TOSHIBA TEC KABUSHIKI KAISHA, Tokyo (JP)

(21) Appl. No.: 12/859,512

(22) Filed: Aug. 19, 2010

(30) Foreign Application Priority Data
Sep. 25, 2009 (JP) 2009-220539

(51) Int. Cl. G06Q 30/00

(52) U.S. Cl. 235/383

(57) ABSTRACT

According to one embodiment, a search unit searches a data file storing article information, and acquires article information corresponding to the article code inputted by a input unit. A storage unit stores a first transaction number indicating a first transaction and article information about the first transaction, a second transaction number indicating a second transaction after the first transaction and article information about the second transaction, and a third transaction number indicating a third transaction after the second transaction and article information about the third transaction. A display unit displays the transaction number of and a total amount for the first transaction, the transaction number of and a total amount for the second transaction, and the transaction number of and a total amount for the third transaction that are stored in the storage unit at the same time, in one display area.

### CROSS-REFERENCE TO RELATED APPLICATIONS

This application is based upon and claims the benefit of priority from Japanese Patent Application No. 2009-220539, filed Sep. 25, 2009; the entire contents of which are incorporated herein by reference.

### FIELD

Embodiments described herein relate generally to an article sales data processing apparatus which scans code symbols by using a code scanner and carries out various kinds of processing for article sales based on the scanned code symbols.

### BACKGROUND

A point of sales (POS) terminal is an example of an article sales data processing apparatus. A store such as a supermarket introduces a POS terminal as a settlement terminal. As the POS terminal is introduced, an article code is allocated to each article that is sold in the store. An article code is symbolized in the form of a code symbol such as barcode and then attached to an article. When a salesclerk uses a code scanner to optically scan a code symbol attached to an article, the article code of the article is inputted to the POS terminal.

When the article codes of all the articles that one customer intends to purchase are inputted to the POS terminal, the salesclerk operates the POS terminal and carries out checkout with this customer. However, even though the salesclerk carries out the checkout, if the customer takes long to pay the price of the articles, the checkout is suspended then.

Conventionally, an electronic cash register having a function of temporarily suspending an operation for the first customer is known. This electronic cash register can scan the barcode on an article that the subsequent customer intends to purchase while the operation for the first customer is suspended.

On the electronic cash register, a display screen of a display device is vertically or horizontally divided into equal parts. The electronic cash register displays information of the articles to be purchased including the articles codes inputted by using the code scanner, for each of the first customer and the subsequent customer.

### BRIEF DESCRIPTION OF THE DRAWINGS

FIG. 1 is a perspective view showing an article sales data processing apparatus as a whole in a first embodiment.

FIG. 2 is a block diagram showing the electrical configuration of the article sales data processing apparatus.

FIG. 3 is a flowchart showing the flow of article code input executed by a microcomputer of an article code input device.

FIG. 4 is a schematic view showing an example of display contents displayed on a scan display of the article code input device during the article code input.

FIG. 5 is a schematic view showing an example of display contents displayed on a customer display of the article code input device during the article code input.

FIG. 6A and FIG. 6B are schematic views showing an example of display contents displayed on a settlement display of a POS terminal during the execution of settlement.

FIG. 7A and FIG. 7B are explanatory views showing operation procedures to operate a touch panel and switch the order of transactions.

FIG. 8 is a schematic view showing an example of transition of display contents on the settlement display of the POS terminal during the execution of settlement.

FIG. 9 is a schematic view showing an example of display contents displayed on the settlement display of the POS terminal during the execution of settlement in a second embodiment.

FIG. 10 is a schematic view showing an example of display contents displayed on the settlement display of the POS terminal during the execution of settlement in a third embodiment.

### DETAILED DESCRIPTION

In general, according to one embodiment, an article sales data processing apparatus includes an input unit, a search unit, a storage unit, and a display unit. The input unit inputs an article code. The search unit searches a data file storing article information including an article name and a unit price corresponding to an article code of each article, and acquires article information corresponding to the article code inputted by the input unit. The storage unit stores a first transaction number indicating a first transaction and article information about the first transaction, a second transaction number indicating a second transaction after the first transaction and article information about the second transaction, and a third transaction number indicating a third transaction after the second transaction and article information about the third transaction. The display unit displays the transaction number of and a total amount for the first transaction, the transaction number of and a total amount for the second transaction, and the transaction number of and a total amount for the third transaction that are stored in the storage unit at the same time, in one display area.

Hereinafter, plural embodiments will be described with reference to the drawings. Each embodiment is an example of application to an article sales data processing apparatus 101 introduced in an checkout area of a supermarket. This apparatus 101 inputs article codes and carries out settlement while customers and articles brought by the customers are moved in one direction.

### First Embodiment

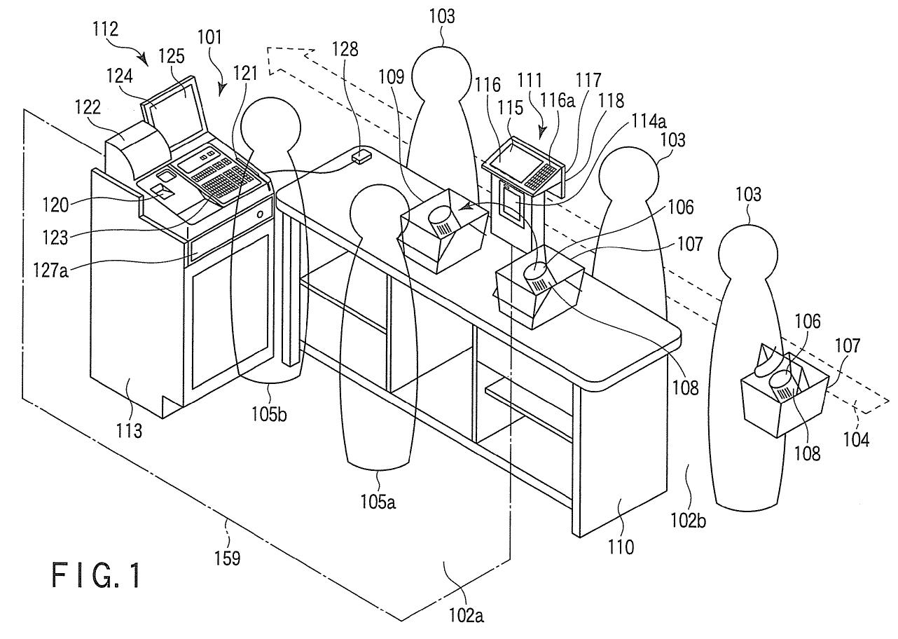

A first embodiment will be clarified with reference to FIG. 1 to FIG. 8.

FIG. 1 is a perspective view showing the article sales data processing apparatus 101 as a whole. An elongate rectangular counter 110 is installed in a checkout area of a supermarket. The counter 110 divides the checkout area into a salesclerk space 102a and a customer space 102b.

In the salesclerk space 102a, a checker 105a and a cashier 105b stand by. The checker 105a is in charge of scanning a code symbol 108 using an article code input device 111. The cashier 105b is in charge of settlement using a POS terminal 112.

In the customer space 102b, a customer passage 104 is prescribed along a lateral side of the counter 110. A customer 103 brings an article 106 which the customer intends to purchase and which is put in a shopping basket 107, to the checkout area. The customer 103 places the shopping basket 107 on the counter 110 and then moves the customer passage 104 in a direction from bottom right to top left in FIG. 1. The customer 103 then carries out checkout of the article 106 which the customer intends to purchase, with salesclerks (the checker 105a and the cashier 105b).

The article sales data processing apparatus 101 includes the article code input device 111 as an input unit, and the POS terminal 112 as a settlement unit. The article code input device 111 is installed upright at a position that is substantially central in the direction of the longer side of the counter 110 and close to the customer space 102b on the top side of the counter 110. The POS terminal 112 is installed together with a drawer 127a, on a POS terminal installing table 113. The POS terminal installing table 113 is installed at a position that is downstream in the direction of the movement of the customer 103 moving along the customer passage 104 and near the counter 110 within the salesclerk space 102a. The POS terminal 112 is connected with the article code input device 111 by a connection cord 159 in such a manner that data can be communicated.

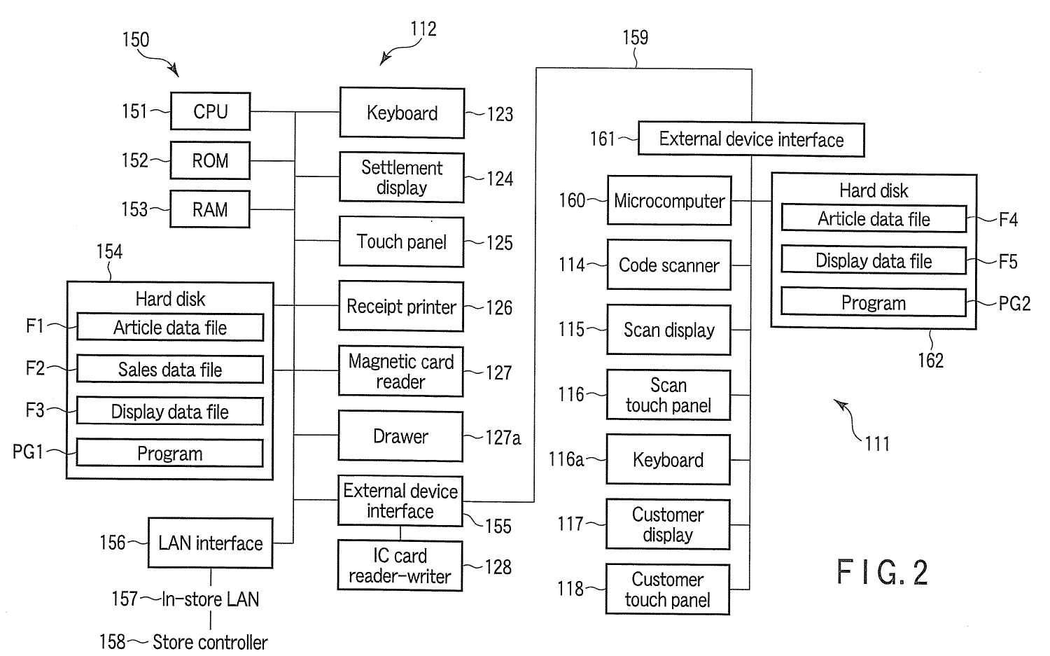

The article code input device 111 includes a code scanner 114 (see FIG. 2). The article code input device 111 is also provided with a scan window 114a facing the direction of the salesclerk space 102a. The code scanner 114 optically scans the code symbol 108 attached to each article that is sold in the supermarket, via the scan window 114a. The code scanner 114 decodes the scanned code symbol 108 to an article code. The decoded article code is inputted to the POS terminal 112 via the connection cord 159.

The article code input device 111 further has a scan display 115, a scan touch panel 116, a keyboard 116a, a customer display 117, and a customer touch panel 118.

The scan display 115 is attached to the top end of the article code input device 111, with the display surface of the scan display 115 facing the direction of the salesclerk space 102a. The scan touch panel 116 is arranged by being superimposed on the display surface of the scan display 115. The keyboard 116a is attached to the right side of the display surface of the scan display 115. The customer display 117 is attached to the back side of the scan display 115, with the display surface of the customer display 117 facing the direction of the customer space 102b. The customer touch panel 118 is arranged by being superimposed on the display surface of the customer display 117.

The checker 105a stands at a position facing the article code input device 111, in the salesclerk space 102a. When the shopping basket 107 is placed on the counter 110, the checker 105a positions the shopping basket 107 to the right side of the article code input device 111, that is, upstream in the direction of the movement of the customer 103 moving along the customer passage 104. Subsequently, the checker 105a scans the code symbol 108 attached to the article 106 which the customer intends to purchase and is put in the shopping basket 107.

First, the checker 105a positions an empty shopping basket 109 to the left side of the article code input device 111 on the top side of the counter 110, that is, downstream in the direction of the movement of the customer 103 moving along the customer passage 104. Then, the checker 105a takes the article 106 from the shopping basket 107 and holds the code symbol attached to the article 106 over the scanning window 114a. The checker 105a then confirms that the code symbol is scanned by the code scanner 114, through a sound or display. After the code symbol is scanned by the code scanner 114, the checker 105a puts the article 106 in the shopping basket 109. The checker 105a repeats the above scan until there is no longer any article 106 in the shopping basket 107.

The cashier 105b stands at a position facing the POS terminal 112 in the salesclerk space 102a. The cashier 105b operates the POS terminal 112 to carry out settlement based on the article code inputted to the POS terminal 112 from the article code input device 111.

The POS terminal 112 has a housing 122 which has a receipt issue port 120 and a magnetic card reading groove 121 provided on the top side of the housing 122. The housing 122 has a keyboard 123 and a settlement display 124 mounted on the top side. The display 124, functioning as a display unit, has a touch panel 125. The touch panel 125 is arranged by being superimposed on the display surface of the display 124.

The POS terminal 112 has a receipt printer 126 (see FIG. 2) and a magnetic card reader 127 (see FIG. 2) included in the housing 122. The receipt printer 126 prints a receipt. The POS terminal 112 issues the receipt printed by the receipt printer 126, from the receipt issue port 120. The magnetic card reader 127 reads information stored on a magnetic card inserted in the magnetic card reading groove 121 and inputs the information to a microcomputer 150 (see FIG. 2).

The POS terminal 112 is connected with an IC card reader-writer 128. The reader-writer 128 reads data from and writes data to an IC card by short-distance wireless communication. The IC card reader-writer 128 is attached near the downstream edge in the direction of the movement of the customer 103 moving along the customer passage 104, on the top side of the counter 110.

FIG. 2 is a block diagram showing the electrical configuration of the article sales data processing apparatus 101. The POS terminal 112 is equipped with the microcomputer 150 as an information processing unit. The microcomputer 150 includes a central processing unit (CPU) 151, a read only memory (ROM) 152, and a random access memory (RAM) 153.

The microcomputer 150 controls the driving of the keyboard 123, the touch panel 125, the settlement display 124, the receipt printer 126, the magnetic card reader 127, the drawer 127a, a hard disk 154, an external device interface 155, and a LAN interface 156.

The hard disk 154 saves data files and a program PG1. The data files include an article data file F1, a sales data file F2, and a display data file F3. The program PG1 includes an operating system (OS), a driver program, and an application program.

The article data file F1 stores article information such as article names and article unit prices corresponding to article codes. The sales data file F2 stores sales information. The display data file F3 stores image data such as various icons to be displayed on the settlement display 124.

The external device interface 155 implements data communication between the POS terminal 112 and the article code input device 111 and data communication between the POS terminal 112 and the IC card reader-writer 128. The LAN interface 156 implements data communication between a store controller 158 connected via a local area network (LAN) 157 arranged in the store and the POS terminal 112.

The microcomputer 150 reads all or a part of the program PG1 into the RAM 153 when the POS terminal 112 is started. As the program PG1 is read, the microcomputer 150 executes the following processings 1 to 5 according to the description of the program PG1. An article data file F4 and a display data file F5 will be described later.

1. Settlement.

2. Processing to send the sales information stored in the sales data file F2 to the store controller 158.

3. Processing to store the article information and image data distributed from the store controller 158, in the article data file F1 or the display data file F3.

4. Processing to send the article information to the article code input device 111 and implement synchronization of the article data file F1 and the article data file F4 between the article code input device 111 and the POS terminal 112.

5. Processing to send the image data to the article code input device 111 and implement synchronization of the display data file F3 and the display data file F5 between the article code input device 111 and the POS terminal 112.

The article code input device 111 is equipped with a microcomputer 160 as an information processing unit. The microcomputer 160 controls the driving of the code scanner 114, the scan display 115, the scan touch panel 116, the keyboard 116a, the customer display 117, the customer touch panel 118, an external device interface 161, and a hard disk 162.

The hard disk 162 saves the article data file F4, the display data file F5, and a program PG2. The program PG2 includes an OS, a driver program, and an application program.

The microcomputer 160 reads the program PG2 when the article code input device 111 is started. As the program PG2 is read, the microcomputer 160 implements various kinds of processing including article code input according to the description of the program PG2.

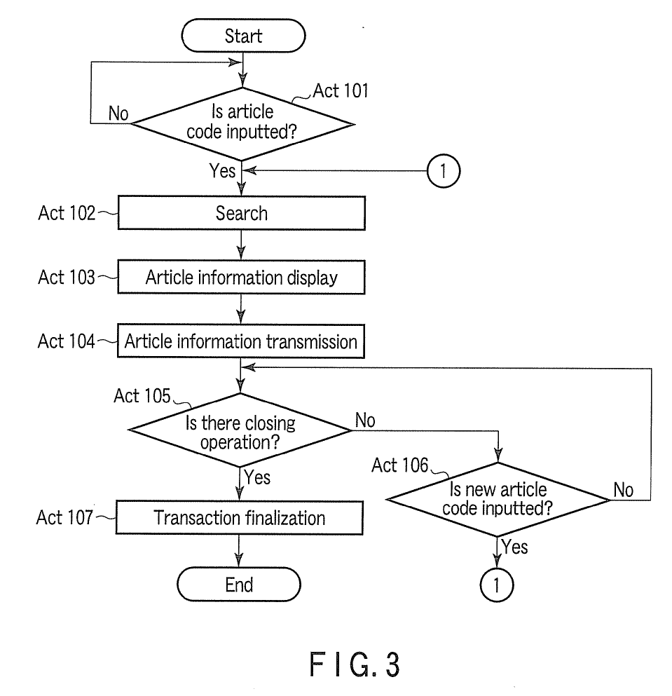

FIG. 3 is a flowchart showing the flow of the article code input. When the article code input is started, the microcomputer 160 waits for an input of an article code (ACT 101).

When an article code is inputted from the code scanner 114 (YES in ACT 101), the microcomputer 160 executes search (ACT 102). That is, the microcomputer 160 searches the article data file F4 in order to acquire article information corresponding to the article code inputted from the code scanner 114. Here, the microcomputer 160 functions as a search unit.

When the article information is acquired by the search, the microcomputer 160 executes article information display (ACT 103). That is, the microcomputer 160 displays information of article name, unit price and the like included in the article information that is acquired this time, on the scan display 115 and the customer display 117.

When the article information is displayed by the article information display, the microcomputer 160 executes article information transmission (ACT 104). That is, the microcomputer 160 sends the article information that is acquired this time, to the POS terminal 112 via the external device interface 161.

When the article information is sent by the article information transmission, the microcomputer 160 determines whether there is a closing operation or not (ACT 105). When there is no closing operation (NO in ACT 105), the microcomputer 160 waits for an input of a new article code (ACT 106).

When a new article code is inputted (YES in ACT 106), the microcomputer 160 executes search in order to acquire article information corresponding to this article code (ACT 102).

Where there is a closing operation from the keyboard 116a (YES in ACT 105) before a new article code is inputted (NO in ACT 106), the microcomputer 160 executes transaction finalization (ACT 107). That is, the microcomputer 160 sends closing information to the POS terminal 112 via the external device interface 161 in order to finalize the article information sent to the POS terminal 112 as the article information about one transaction.

When the closing information is sent by the transaction finalization, a series of processes of the article code input end.

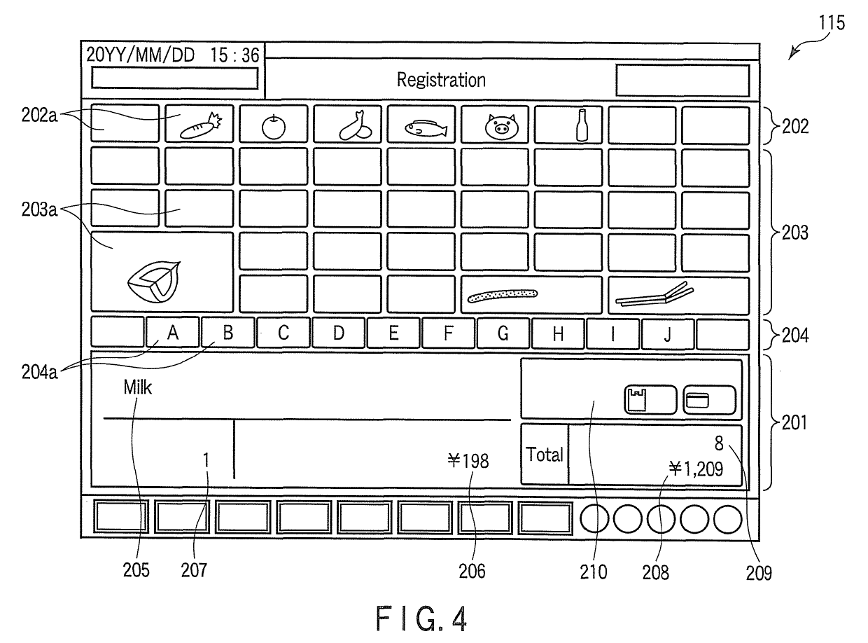

While executing the article code input, the microcomputer 160 causes the scan display 115 to display a registration screen. FIG. 4 shows an example of the displayed registration screen. In the registration screen, as shown in FIG. 4, a category button section 202, an article button section 203, a search button section 204, and an article information display section 201 are arranged in order from the top to the full width of the screen.

The article information display section 201 displays the article name 205, the unit price 206 and the number of individual items 207 included in the article information acquired by the search (ACT 102 in FIG. 3), in the timing of executing the article information display (ACT 103 in FIG. 3). The number of individual items 207 increases as the same article code is inputted consecutively. Therefore, the checker 105a can learn the details of the article information inputted to the POS terminal 112 on the basis of the display content in the article information display section 201.

The article information display section 201 displays the total amount 208, the total number of items 209, and a request content icon 210. The total amount 208 and the total number of items 209 are calculated on the basis of the article information acquired after the input of the article code is started. The display contents of the total amount 208 and the total number of items 209 are updated in the timing of executing the article information display. The request content icon 210 will be described later.

The category button section 202, the article button section 203 and the search button section 204 display button images to assist the checker 105a in inputting the article code to the POS terminal 112 via the scan touch panel 116. The data of each button image is stored in the display data file F5.

The category button section 202 includes plural category buttons 202a to which the categories of articles sold in the supermarket are allocated. As the checker 105a touches one of the category buttons 202a, plural article buttons 203a indicating plural articles belonging to the category allocated to that category button 202a are deployed in the article button section 203.

In the example shown in FIG. 4, the category button 202a corresponding to “vegetables” is touched. In the article button section 203, the article buttons 203a of “pumpkin”, “cucumber”, “Welsh onion” and the like are deployed.

The deployment of the article buttons 203a in the article button section 203 is also implemented by a touch on a search button 204a included in the search button section 204. For example, when the search button 204a of “A” is touched, various article buttons 203a to input article codes of article names starting with “A” are deployed in the article button section 203.

As the checker 105a touches one of the article buttons 203a, the microcomputer 160 executes the search, the article information display, and the article information transmission, using the article code of the article allocated to that article button 203a. Therefore, the checker 105a can input the article code without using the code scanner 114.

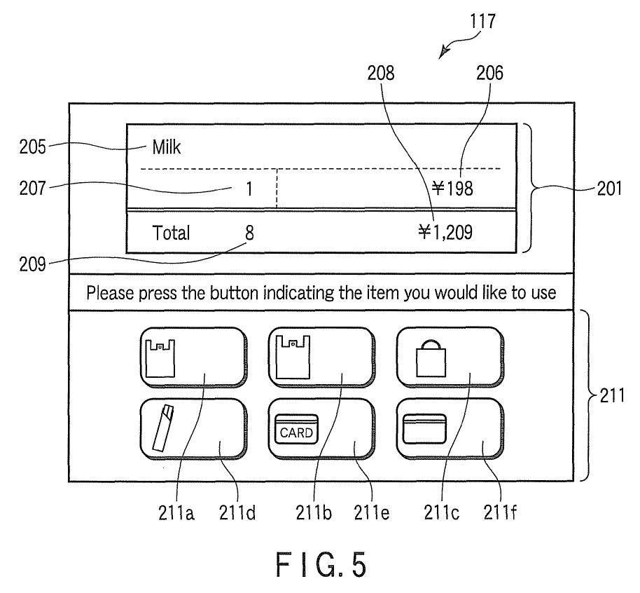

While executing the article code input, the microcomputer 160 causes the customer display 117 to display a customer screen. FIG. 5 shows an example of the displayed customer screen. In the customer screen, as shown in FIG. 5, the article information display section 201 is arranged in the top half and a request button display section 211 is arranged in the bottom half. The elements included in the article information display section 201 is the same as the elements displayed on the scan display 115 and therefore will not be described further in detail here.

In the request button display section 211, button images are displayed including a small checkout bag request button 211a, a large checkout bag request button 211b, a paper bag request button 211c, a disposable chopsticks request button 211d, a credit card settlement declaration button 211e, and a point use declaration button 211f. The data of each button image is stored in the display data file F5.

The customer 103 confirming the customer screen can touch the buttons 211a to 211f in the request button display section 211. The time when the customer can touch the buttons 211a to 211f is not limited to when the checker 105a is carrying out the operation to scan the code symbol 108. Even after the checker 105a operates the closing key provided on the keyboard 106a, the customer can touch the buttons before the transaction with the next customer 103 is started.

The microcomputer 160 causes the scan display 115 to display the request content icon 210 corresponding to the touched buttons 211a to 211f. The microcomputer 160 also sends request information indicating that the buttons 211a to 211f are touched, to the POS terminal 112.

During the startup of the device, the microcomputer 150 of the POS terminal 112 waits for reception of information sent from the article code input device 111 according to the description of the program PG1. When article information (article name, unit price and the like) is received from the article code input device 111, the microcomputer 150 stores the received article information in the RAM 153.

When closing information is received from the article code input device 111, the microcomputer 150 finalizes the article information that is stored in the RAM 153 and is not finalized yet, as article information about one transaction. The microcomputer 150 holds the finalized article information about one transaction in the RAM 153 until settlement ends, which will be described later.

Even before the settlement ends with respect to the finalized article information about one transaction, when article information is received from the article code input device 111, the microcomputer 150 stores the received article information in the RAM 153. Meanwhile, when closing information is received from the article code input device 111, the microcomputer 150 finalizes the article information that is stored in the RAM 153 and is not finalized yet, as article information about one transaction.

Therefore, finalized article information about each transaction and article information that is not finalized yet as article information about one transaction are stored in the RAM 153. That is, in the RAM 153, first article information about the transaction that should be settled first (hereinafter referred to as the earliest transaction), second article information about the second transaction, and third article information about the third transaction are stored in predetermined areas, respectively. Here, the RAM 153 functions as a storage unit.

During the startup of the device, the microcomputer 150 executes the settlement according to the description of the program PG1. That is, the microcomputer 150 calculates the transaction amount that the customer should pay on the basis of the article information finalized as the earliest transaction, of the article information stored in the RAM 153. The microcomputer 150 then carries out settlement of the transaction amount.

For example, when deposit amount data is inputted from the keyboard 123 of the POS terminal 112, the microcomputer 150 carries out settlement by cash. When magnetic information on a credit card is read by the magnetic card reader 127, the microcomputer 150 carries out settlement by credit card. When an IC card storing electronic money information held by the customer 103 is held over the IC card reader-writer 128, the microcomputer 150 carries out settlement by electronic money.

After the settlement is completed, the microcomputer 150 stores various kinds of information including the transaction amount, the deposit amount, the amount of change, and the article information about this transaction in the sales data file F2. The microcomputer 150 also controls the driving of the receipt printer 126 and outputs the printed receipt from the receipt issue port 120.

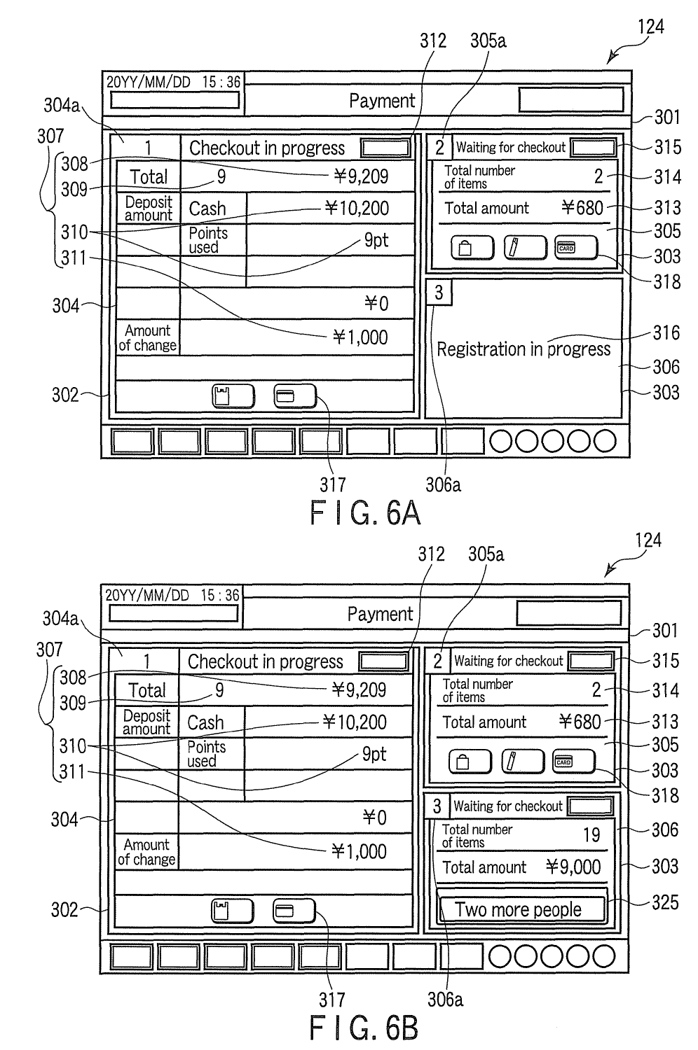

In order to assist the cashier in the settlement, the microcomputer 150 causes the settlement display 124 to display a settlement screen while carrying out the settlement. FIG. 6A and FIG. 6B show an example of the displayed settlement screen.

The microcomputer 150 defines a settlement area 302 and two settlement waiting areas 303 that are smaller than the settlement area 302 in advance in a display area 301 of the settlement display 124.

The settlement area 302 is provided on the left side within the display area 301. The settlement area 302 occupies half the width of the display area 301 or more, and has a height such that the top and bottom of the settlement area 302 are close to the top and bottom within the display area 301. The two settlement waiting areas 303 are vertically arrayed between the right end side of the display area 301 and the right end side of the settlement area 302.

The microcomputer 150 controls the settlement display 124 while carrying out the settlement. With this control, the settlement area 302 displays a settlement window 304 as a first area. The upper settlement waiting area 303 displays a next-customer window 305 as a second area. The lower settlement waiting area 303 displays a customer-after-next window 306 as a third area.

The area of the settlement window 304 occupies approximately three-fourths of the entire area of the settlement display 124. The next-customer window 305 and the customer-after-next window 306 occupy the remaining area, which is approximately one-fourth.

The settlement screen shown in FIG. 6A will now be described. The settlement window 304 displays transaction amount information 307 about the earliest transaction as the first transaction. Moreover, at the top left part of the settlement window 304, a first transaction number 304a of “1” is displayed indicating that the information about the earliest transaction is displayed.

The transaction amount information 307 includes the transaction amount 308, the number of items sold 309, the deposit amount 310, and the amount of change 311. The transaction amount 308 is calculated by the microcomputer 150 on the basis of the unit price included in the article information about the earliest transaction, of the article information stored in the RAM 153. The microcomputer 150 displays the transaction amount 308 irrespective of whether the article information is finalized as the article information about the earliest transaction or not. When necessary, a proper amount of tax is added to or a discount amount is subtracted from the transaction amount 308.

The number of items sold 309 is calculated by the microcomputer 150 on the basis of the number of individual items included in the article information about the earliest transaction, of the article information stored in the RAM 153. The deposit amount 310 is inputted to the POS terminal 112 when the cashier 105b operates the POS terminal 112 after the article information about the earliest transaction is finalized.

The settlement screen shown in FIG. 6A shows “cash 10,200 yen” as the deposit amount 310 and “points used 9pt”. “Cash 10,200 yen” is the amount inputted by the cashier 105b via the keyboard 123 of the POS terminal 112. “Points used 9pt” is the points that are acquired as the cashier 105b swipes the member card received by the cashier 105b from the customer 103, through the magnetic card reading groove 121. In this example of the settlement screen, 1 point is converted to 1 yen and thus used for settlement.

The member card is provided with a magnetic tape on which a member code is stored. As the cashier 105b swipes the member card through the magnetic card reading groove 121, the member code is inputted to the POS terminal 112 via the magnetic card reader 127. The microcomputer 150 of the POS terminal 112 sends the inputted member code to the store controller 158 in order to acquire point information for the customer 103 stored in a point database within the store controller 158.

The amount of change 311 is the amount as a result of subtracting the transaction amount 308 from the deposit amount 310. As the cashier 105b presses a settlement key provided on the keyboard 123 in the state where the deposit amount 310 is inputted, the amount of change 311 is displayed. The pressing of the settlement key triggers the processing to store sales data in the sales data file F2, the processing to drive the receipt printer 126 and issue a receipt, and the processing to send an open signal to the drawer 127a. The microcomputer 150 executes all these processings.

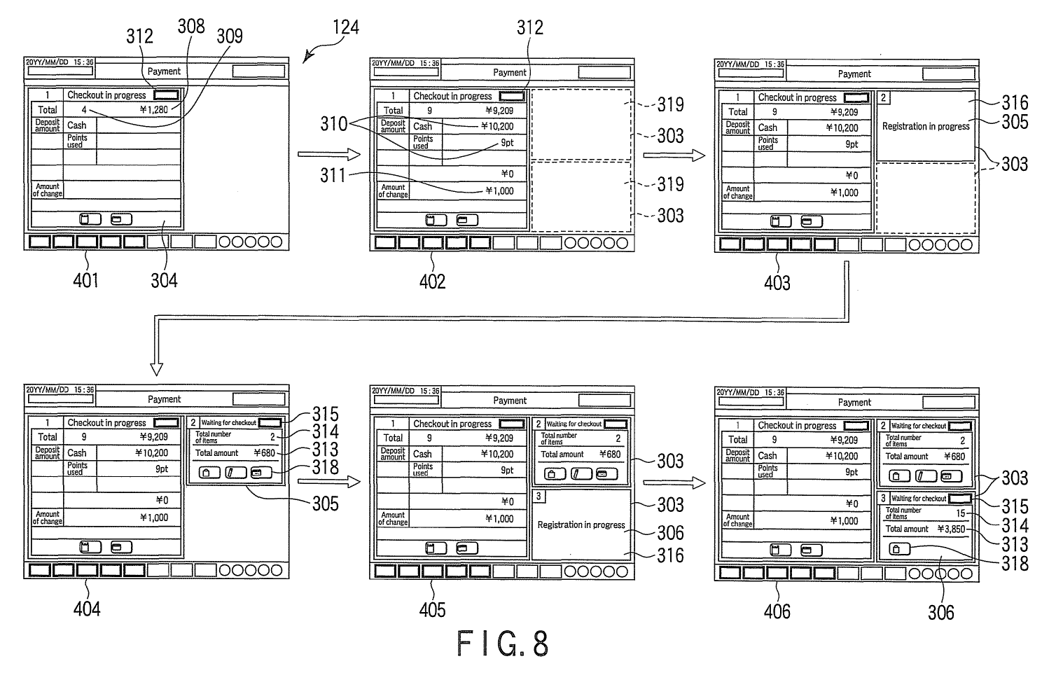

A switch button 312 to switch to a registration detail screen is arranged at a top right part of the settlement window 304. The switch button 312 is grayed out before the article information about the earliest transaction is finalized. When the article information about the earliest transaction is finalized, the switch button 312 is highlighted (see screens 401 and 402 of FIG. 8).

As the cashier 105b touches the switch button 312 while the switch button 312 is highlighted, the microcomputer 150 displays a screen showing the details of the article information about the earliest transaction, in the entire display area 301. The detail screen shows the article information including the article name and unit price stored in the RAM 153. Also, a return button is arranged in the detail screen. When the return button is touched, the microcomputer 150 returns the display content in the display area 301 to the state of FIG. 6A.

The next-customer window 305 and the customer-after-next window 306 correspond to transactions following the earliest transaction. More specifically, the next-customer window 305 corresponds to a transaction that is second in order, which is the second transaction. The customer-after-next window 306 corresponds to a transaction that is third in order, which is the third transaction.

At a top left part of the next-customer window 305, a second transaction number 305a of “2” is displayed which indicates that the information about the second transaction is displayed. At a top left of the customer-after-next window 306, a third transaction number 306a of “3” is displayed which indicates that the information about the third transaction is displayed.

The next-customer window 305 and the customer-after-next window 306 display the state of the corresponding transactions, respectively. The display of the state includes a first state indicating that the article information about one transaction is finalized and the customer is waiting for settlement, a second state where the checker 105a is now having the code symbol 108 read and inputting the article code and the article information is not finalized, and a third state where the input of the article code is not started.

FIG. 6A shows the display area 301 where the second transaction is in the first state and the third transaction is in the second state. The next-customer window 305 in the first state displays the transaction amount 313 as the total amount of the second transaction, and the number of items sold 314. The transaction amount 313 and the number of items sold 314 are calculated by the microcomputer 150 on the basis of the article information about the second transaction stored in the RAM 153.

At a top right part of the next-customer window 305, a switch button 315 to switch to a registration detail screen is arranged. As the cashier 105b touches the switch button 315, the microcomputer 150 displays a screen showing the details of the article information about the second transaction, in the entire display area 301.

The customer-after-next window 306 in the second state displays a message 316 indicating that the code symbol 108 is now being read with respect to the third transaction, for example, a message “Registration in progress”. The customer-after-next window 306 does not display any of the transaction amount 313, the number of items sold 314 and the registration detail screen switch button 315.

By the way, when the second or third transaction is in the third state where even the reading of the code symbol 108 is not carried out yet, the microcomputer 150 does not display the next-customer window 305 or the customer-after-next window 306. The microcomputer 150 draws the settlement waiting areas 303 in the same color as the background color (see screens 401, 402, 403 and 404 of FIG. 8).

In FIG. 6A, a request icon 317 is displayed at a lower part of the settlement window 304. As the customer 103 in the earliest transaction touches the buttons 211a to 211f in the request button display section 211 displayed on the customer display 117, the request icon 317 is displayed. These image data are stored in the display data file F3.

With the request icon 317, the settlement screen shown in FIG. 6A shows that the large checkout bag request button 211b and the point use declaration button 211f are pressed by the customer 103 who carries out the earliest transaction. Similarly, a request icon 318 is displayed at a lower part of the next-customer window 305. That is, with the request icon 318, the settlement screen shows that the buttons 211a to 211f in the request button display section 211 are pressed by the customer who carries out the second transaction.

The settlement screen shown in FIG. 6B will now be described. This screen is shown when four or more customers are waiting for payment. As shown in FIG. 6B, the microcomputer 150 displays a pop-up window 325 at the site where the request icon 318 should be displayed in the customer-after-next window 306. The microcomputer 150 then displays the number of transactions with respect to the fourth and the subsequent transactions in the window 325.

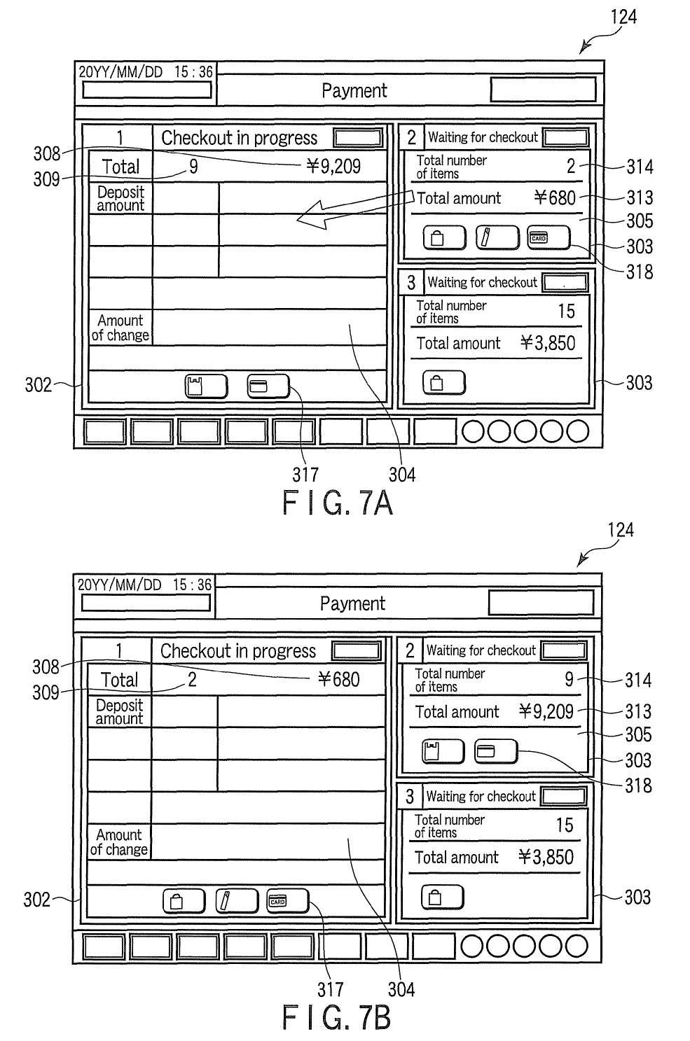

FIG. 7A and FIG. 7B are explanatory views showing the operation procedures to operate the touch panel 125 from the settlement screen and switch the order of transactions. The display contents of the settlement window 304, the next-customer window 305 and the customer-after-next window 306 displayed on the settlement display 124 can be switched by a drag operation on the touch panel 125. Moreover, with this switching, the order of transactions is switched as well.

More specifically, when the microcomputer 150 determines that there is a drag operation on the touch panel 125, the microcomputer 150 detects the coordinates of the starting point of the drag operation and the coordinates of the ending point. The microcomputer 150 then determines whether or not the coordinates of the starting point and the coordinates of the ending point are included in two different areas of the settlement area 302 and the two settlement waiting areas 303. When these coordinates are included in two different areas, the microcomputer 150 switches the order of the transaction corresponding to the area including the coordinates of the starting point and the transaction corresponding to the area including the coordinates of the ending point, of the article information stored in the RAM 153, and re-stores the order. The microcomputer 150 updates the display contents on the settlement display 124.

FIG. 7A shows an example in which the cashier 105b strokes the touch panel 125 to drag from the next-customer window 305 to the settlement window 304. In this case, the coordinates of the starting point of the drag are included in the upper settlement waiting area 303 and the coordinates of the ending point are included in the settlement area 302.

The microcomputer 150 re-stores the article information about the earliest transaction of the article information stored in the RAM 153, as the article information about the second transaction. The microcomputer 150 also re-stores the article information about the second transaction as the article information about the earliest transaction. Moreover, the microcomputer 150 adjusts the display contents in the settlement window 304 and the next-customer window 305 displayed on the settlement display 124, on the basis of the contents re-stored in the RAM 153.

As a result, the settlement screen displays the contents of the earliest transaction and the contents of the second transaction that are switched, as shown in FIG. 7B. The cashier 105b can carry out settlement of the second transaction first.

FIG. 8 is a schematic view showing an example of transition of the display contents on the settlement display 124 of the POS terminal 112 during the execution of the settlement. Hereinafter, the case of carrying out checkout in a two-people system involving the checker 105a and the cashier 105b using the article sales data processing apparatus 101 according to this embodiment in which the screen display as shown in FIG. 8 is provided, will be described.

First, the checker 105a stands in front of the article code input device 111 and scans the code symbol 108. Then, the transaction amount 308 and the number items sold 309 for articles on which the scanning of the code symbol 108 is finished are displayed in the settlement window 304 on the settlement display 124 (screen 401 of FIG. 8). At this time, since the article information about the earliest transaction is not finalized, the switch button 312 grayed out.

When the scanning of the code symbols 108 of all the articles 106 put in the shopping basket 107 is finished, the checker 105a presses the closing key provided on the keyboard 116a. Thus, the article information about the earliest transaction is finalized and the switch button 312 is highlighted (screen 402 of FIG. 8).

The cashier 105b stands in front of the POS terminal 112 and carries out the settlement with the customer 103, while the switch button 312 is highlighted. The cashier 105b receives cash and the member card from the customer 103 and inputs the information of the deposit amount 310 to the POS terminal 112. Then, the deposit amount 310 and the amount of change 311 are displayed on the settlement display 124 (screen 402 of FIG. 8).

In this stage, the transactions following the earliest transaction are not started yet. Therefore, only a background color 319 is shown in the settlement waiting areas 303.

As the checker 105a starts scanning the code symbol 108 with respect to the customer 103 who carries out the second transaction before the settlement of the earliest transaction is completed, the next-customer window 305 is displayed in the upper settlement waiting area 303 (screen 403 of FIG. 8).

In this state, the article information about the second transaction is not finalized yet. Therefore, the message 316 “registration in progress . . . ” is displayed in the next-customer window 305.

When the article information about the second transaction is finalized, the message 316 “registration in progress . . . ” disappears from the next-customer window 305. The transaction amount 313, the number of items sold 314, the switch button 315 and the request icon 318 are displayed in the next-customer window 305 (screen 404 of FIG. 8).

Subsequently, as the checker 105a starts scanning the code symbol 108 with respect to the customer 103 who carries out the third transaction, the customer-after-next window 306 including the message 316 “registration in progress . . . ” is displayed in the lower settlement waiting area 303 (screen 405 of FIG. 8).

Then, when the article information about the third transaction is finalized, the message 316 “registration in progress . . . ” disappears from the customer-after-next window 306. The transaction amount 313, the number of items sold 314, the switch button 315 and the request icon 318 are displayed in the customer-after-next window 306 (screen 406 of FIG. 8).

In this manner, in the article sales data processing apparatus 101 according to this embodiment, the next-customer window 305 and the customer-after-next window 306 are displayed in the display area 301 on the settlement display 124. As the checker 105a carries out the scanning of the code symbols 108 one after another, the states of the transactions following the earliest transaction is displayed in the next-customer window 305 and the customer-after-next window 306. That is, which state each transaction is in, of the first state where the article information is finalized, the second state where the input of the article code is in progress and the article information is not finalized yet, and the third state where the input of the article code is not started, is displayed.

As the difference among the displays of the first state, the second state and the third state shown in the next-customer window 305 and the customer-after-next window 306, how each screen looks is largely different, as shown in FIG. 6A, FIG. 6B, FIG. 7A, FIG. 7B and FIG. 8. Therefore, the cashier 105b can confirm the input status of the article information about each of the second and subsequent transactions while carrying out the settlement of the earliest transaction, watching the settlement display 124. Thus, the cashier 105b can concentrate on the settlement.

Moreover, in the article sales data processing apparatus 101 according to this embodiment, the transaction amount information 307 for the earliest transaction is largely displayed in the display area 301. On the contrary, the detailed information including article name and unit price is not displayed unless the switch button 312 is touched and designated. Therefore, there is no risk that the cashier 105b mistakes the transaction amount between the earliest transaction and the second and subsequent transactions.

In this manner, the article sales data processing apparatus 101 allows the cashier 105b and the checker 105a to concentrate on their respective works and can realize faster checkout. Thus, the state where the customer waits for payment of the price of articles can be solved.

Moreover, in the article sales data processing apparatus 101 according to this embodiment, when the article information about the second and subsequent transactions following the earliest transaction is finalized, the transaction amount 313 and the number of items sold 314 are displayed in the next-customer window 305 and the customer-after-next window 306. Therefore, the cashier 105b can estimate the contents of the second and subsequent transactions simply by viewing the settlement display 124 while the progress of the earliest transaction is delayed. Therefore, the cashier 105b can carry out the settlement more efficiently.

Furthermore, in the article sales data processing apparatus 101 according to this embodiment, the order of transactions can be switched by a drag on the settlement display 124. For example, when the progress of the settlement with respect to the first customer 103 is delayed, the settlement with respect to the second customer 103 can be carried out. Thus, checkout can be carried out more efficiently.

### Second Embodiment

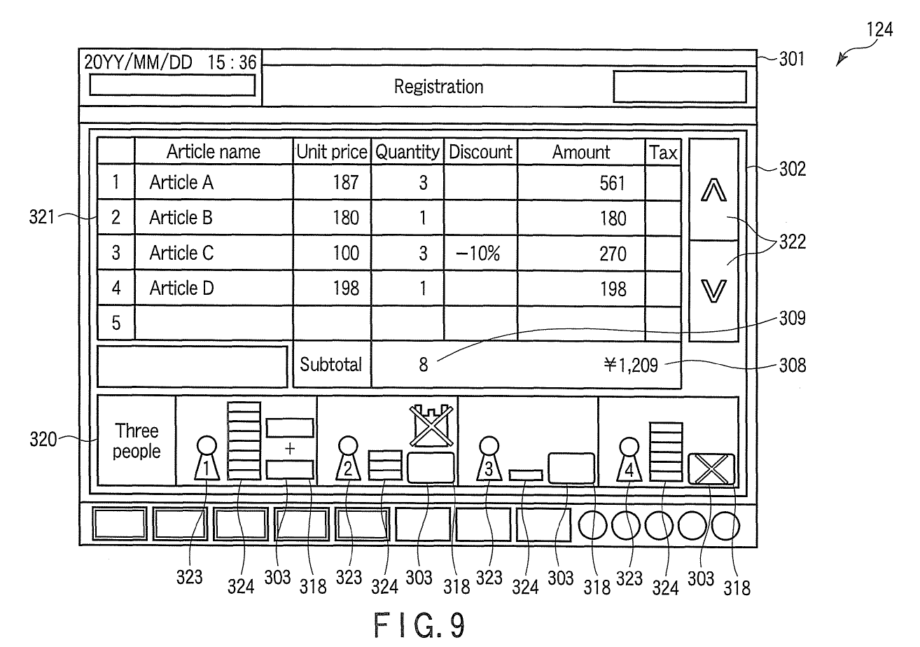

Next, a second embodiment will be described with reference to FIG. 9. The same parts as in the first embodiment are denoted by the same reference numerals and will not be described further in detail. In the second embodiment, the shapes of the settlement area 302 and the settlement waiting areas 303 defined in the display area 301 on the settlement display 124 and the contents displayed in these areas are different from the shapes and contents described in the first embodiment.

FIG. 9 is a schematic view showing an example of the display contents displayed on the settlement display 124 of the POS terminal 112 during the execution of the settlement. The settlement area 302 is provided on the upper side and to the full width within the display area 301 on the settlement display 124. In the display area 301, a number of settlement waiting people display area 320 and fourth settlement waiting areas 303 are laterally arrayed below the settlement area 302.

The settlement area 302 displays an article information list 321 showing the details of the article information about the earliest transaction in the form of a table. The article information list 321 provides fields indicating “article name”, “unit price”, “quantity”, “discount”, “amount”, and “tax” in the direction of columns, and describes records indicating the article information about the earliest transaction in the direction of rows. When scroll buttons 322 displayed on the right end of the settlement area 302 are touched, the article information list 321 scrolls in the direction of rows. The settlement area 302 displays the transaction amount 308 and the number of items sold 309 below the article information list 321.

The number of settlement waiting people display area 320 displays the number of transactions in which settlement is waited for, except for the earliest transaction. Viewing the number displayed in number of settlement waiting people display area 320, the cashier 105b can grasp how many customers are waiting for the payment of the price of articles.

The settlement waiting areas 303 display the article code input status for each transaction including the earliest transaction, in the form of icons. The settlement waiting areas 303 are arrayed laterally and arranged at four positions. In order from the left, the settlement waiting areas 303 correspond to the earliest transaction, the second transaction, the third transaction, and the fourth transaction.

In each settlement waiting area 303, an illustration image 323 expressing the customer 103 and a graph 324 expressing the number of article items which the customer 103 intends to purchase are displayed. Moreover, the request icon 318 as in the first embodiment is displayed in each settlement waiting area 303 as well.

The illustration image 323 is displayed when the scanning of the code symbol 108 is started and the transaction is started. The graph 324 is a bar graph which increases in proportion to the number of items sold in each transaction. The graph 324 is formed as a result of showing, in the form of icons, the numbers of items sold 309 and 314 displayed in the settlement window 304 and the next-customer window 305 or the like in the first embodiment. These image data are stored in the display data file F3.

Also with the article sales data processing apparatus 101 according to this embodiment, the cashier 105b can confirm the input status of the article information about each transaction following the earliest transaction while carrying out settlement, viewing the transaction amount 308 for the earliest transaction which is largely displayed in the display area 301. Thus, the apparatus allows the cashier 105b and the checker 105a to concentrate on their respective works and can realize faster checkout. Consequently, the state where the customer waits for the payment of the price of articles can be solved.

Moreover, in the article sales data processing apparatus 101 according to this embodiment, the number of items sold 309 in each transaction is expressed as an icon and displayed as the graph 324 in the settlement waiting area corresponding to the transaction. Therefore, the cashier 105b can grasp, at a glance, the number of article items which the customer 103 waiting for settlement intends to purchase. Thus, checkout can be made more efficient.

### Third Embodiment

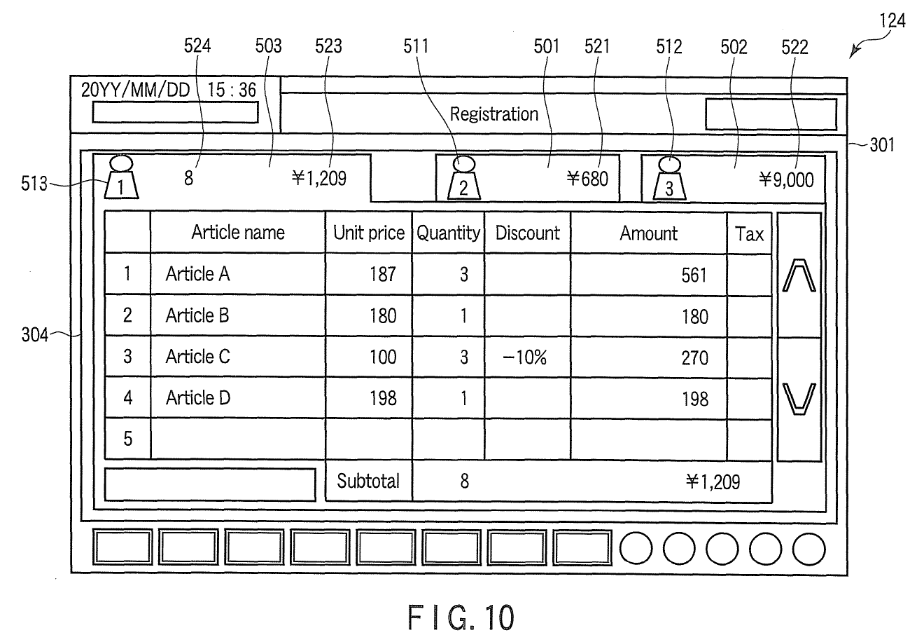

Next, a third embodiment will be described with reference to FIG. 10. The same parts as in the second embodiment are denoted by the same reference numerals and will not be described further in detail. In the article sales data processing apparatus 101 according to this embodiment, the article information list 321 of FIG. 9 is displayed in the settlement window 304 of FIG. 6A and FIG. 6B. In this case, tabs 501 and 502 are displayed on the screen in order to narrow the display areas of the next-customer window 305 and the customer-after-next window 306 (see FIG. 10), whereas the screen is divided for display in FIG. 6A and FIG. 6B.

The tabs 501 and 502 display different illustrations 511 and 512 for the second transaction and the third transaction, respectively. The total amounts 521 and 522 for the transactions are displayed on the tabs. When the tab 501 or the tab 502 is touched, the microcomputer 150 switches the display contents so that the article information list showing the details of the second transaction or the third transaction is shown on substantially the entire screen.

The settlement window 304 has a tab 503 as well. The tab 503 displays an illustration 513 indicating the earliest transaction, and the transaction amount 523 and the number of items sold 524 in the earliest transaction.

The article sales data processing apparatus 101 is not limited to the description of the embodiments. For example, the contents displayed in the next-customer window 305 shown in FIG. 6A can simply be two pieces of information of the transaction number 305a “2” indicating the second transaction and the transaction amount 313. The contents displayed in the customer-after-next window 306 can be similarly configured.

Moreover, the display of the transaction number 305a “2” indicating the second transaction shown in FIG. 6A may be changed to an illustration image expressing the customer as shown in FIG. 9. The other transaction numbers 304a and 306a can be similarly configured.

As for the illustration image, though the illustration indicating a person is shown in FIG. 9, for example, an illustration of a car, animal or the like may be used in FIG. 6A, FIG. 6B and FIG. 9. Different illustrations of cars or animals may be used for the earliest transaction, the second transaction, and the third transaction (for example, an illustration of a bear for the earliest transaction, an illustration of a dog for the second transaction, and an illustration of a cat for the third transaction). Thus, the transactions can easily be distinguished visually.

Although the example where different people operate the article code input device and the POS terminal is described, it is also possible that one person operates the article code input device and the POS terminal. Moreover, a POS terminal device with a handy scanner may be used instead of the article code input device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An article sales data processing apparatus comprising:
an input unit which inputs an article code;
a search unit which searches a data file storing article information including an article name and a unit price corresponding to an article code of each article, and acquires article information corresponding to the article code inputted by the input unit;
a storage unit which stores a first transaction number indicating a first transaction and article information about the first transaction, a second transaction number indicating a second transaction after the first transaction and article information about the second transaction, and a third transaction number indicating a third transaction after the second transaction and article information about the third transaction; and
a display unit which displays the transaction number of and a total amount for the first transaction, the transaction number of and a total amount for the second transaction, and the transaction number of and a total for the third transaction that are stored in the storage unit at the same time, in one display area.

2. The apparatus of claim 1, wherein the display unit divides the one display area into a first area displaying the first transaction number indicating the first transaction and the total amount for the first transaction, a second area displaying the second transaction number indicating the second transaction after the first transaction and the total amount for the second transaction, and a third area displaying the third transaction number indicating the third transaction after the second transaction and the total amount for the third transaction.

3. The apparatus of claim 2, wherein the first area further displays a total number of items, a deposit amount, and an amount of change.

4. The apparatus of claim 3, wherein one of the first area, the second area and the third area has a broader area than the other two areas.

5. The apparatus of claim 4, wherein the display unit has a touch panel superimposed on the display area, and
when the second area or the third area is touched, the touched area is enlarged to the same area as the first area.

6. The apparatus of claim 5, wherein in the display unit, the first area is reduced to the same area as the touched area.

7. The apparatus of claim 2, wherein each of the first, second and third areas displays the transaction number and the total amount in the form of a tab.

8. The apparatus of claim 7, wherein each of the first, second and third areas displays the transaction number by an illustration.

9. The apparatus of claim 2, wherein the second area displays a message indicating that the input of the article code is in progress until the second transaction is finalized as one transaction, and when the second transaction is finalized as one transaction, the second area displays the total amount for the transaction.

10. A transaction display method for an article sales data processing apparatus, comprising:
when an article code is inputted from an input unit,
searching a data file storing article information including an article name and a unit price corresponding to an article code of each article, and acquiring article information corresponding to the article code inputted by the input unit;
storing, in a storage unit, a first transaction number indicating a first transaction and article information about the first transaction, a second transaction number indicating a second transaction after the first transaction and article information about the second transaction, and a third transaction number indicating a third transaction after the second transaction and article information about the third transaction; and
displaying the transaction number of and a total amount for the first transaction, the transaction number of and a total amount for the second transaction, and the transaction number of and a total for the third transaction that are stored in the storage unit at the same time, in one display area on a display unit.
